(19) United States
(12) Patent Application Publication
(10) Pub. No.: US 2009/0117003 A1
(43) Pub. Date: May 7, 2009

(54) LIQUID DELIVERY APPARATUS

(75) Inventor: Arne DEGGERDAL, Lysaker (NO)

Correspondence Address: KNOBBE MARTENS OLSON & BEAR LLP, 2040 MAIN STREET, FOURTEENTH FLOOR, IRVINE, CA, 92614, US

(73) Assignee: Mole Genetics AS, Lysaker (NO)

(21) Appl. No.: 12/204,765

(22) Filed: Sep. 4, 2008

(30) Foreign Application Priority Data
Sep. 7, 2007 (GB) 0717462. 6

(51) Int. Cl. B01L 3/02; B01J 19/00

(52) U.S. Cl. 422/63; 422/100

(57) ABSTRACT

Provided is a pipette head assembly and tip holder apparatus for use in an automated liquid handling device, which apparatus comprises a pipette head assembly mountable in the device and a pipette tip holder comprising locations for holding pipette tips for the pipette head assembly;
wherein the pipette head assembly comprises at least one pipette head cone for liquid delivery to at least one pipette tip, each cone fitting tightly into an opening at the top of the pipette tip, and a plate locating means positioned precisely in relation to the at least one head cone;
wherein the pipette tip holder comprises a plate for aligning the at least one pipette tip for fitting onto the at least one pipette head cone and a support for supporting the plate, which plate is laterally movable on the support and comprises head assembly locating means positioned precisely in relation to the position of location of the at least one pipette tip; and
wherein the head assembly locating means and plate locating means interact to guide the plate when the pipette head assembly is brought into proximity thereto, so as to fit the at least one pipette tip into the at least one head cone.

The present invention relates to a pipette head assembly and tip holder apparatus for use in an automated liquid handling device, a pipette head assembly and a pipette tip holder plate.

Automated liquid handling devices are commonly used in laboratories. In molecular biology, for example, nucleic acid separation processes may be operated in an automated device often using magnetic particles as a means to separate the nucleic acid from contaminating material. Devices are commercially available which may include an automated pipette head assembly movable within the device so that it may be aligned with test tubes or vials for reagent liquid handling. Apparatus of this type has been made to very high standards of engineering, using high quality durable machinery which may be precision manufactured to ensure that operation of the device is reliable. Usually, devices of this type include a dedicated microcomputer to enable programmable control of the processes which the device must perform. Such devices are generally expensive to purchase and may require specialist service contracts for maintenance.

In operation, a pipette head assembly has to pick up disposable pipette tips, often on more than one occasion. A pipette tip holder is typically used as a reservoir for clean pipette tips and generally comprises a plurality of locations in a row for holding pipette tips for the pipette head assembly to take up. The pipette head assembly may be mounted on a movable mounting driven by motors in both horizontal and vertical directions. Typically, the pipette head assembly is horizontally aligned so that it is directly above the pipette tip holder. In a vertical movement downwards, downwardly depending cones on the pipette head assembly are push-fitted into the openings at the top of corresponding pipette tips. This is necessarily a tight fit so as to ensure that the pipette tips do not disengage and so that reagent leakage does not occur.

In order to ensure that this operation is carried out successfully, the pipette tip holder must be manufactured to a high quality with each location for holding a pipette tip positioned precisely to receive a corresponding pipette head cone. Generally, the pipette tip holder is made of high quality material such as stainless steel and made to form part of a work surface tray of the same material and quality. The work surface tray is positioned precisely within the device below the mounting of the pipette head assembly. Accordingly, relatively narrow tolerances in engineering have been used to produce devices of this type and are commonly engineered with a tolerance of no more than ±0.4 mm.

Production costs are very high in the manufacture of devices of this type.

The present invention provides a pipette head assembly and tip holder apparatus for use in an automated liquid handling device, which apparatus comprises a pipette head assembly mountable in the device and a pipette tip holder comprising locations for holding pipette tips for the pipette head assembly;
wherein the pipette head assembly comprises at least one pipette head cone for liquid delivery to at least one pipette tip, each cone fitting tightly into an opening at the top of the pipette tip, and a plate locating means positioned precisely in relation to the at least one head cone;
wherein the pipette tip holder comprises a plate for aligning the at least one pipette tip for fitting onto the at least one pipette head cone and a support for supporting the plate, which plate is laterally movable on the support and comprises head assembly locating means positioned precisely in relation to the position of location of the at least one pipette tip; and
wherein the head assembly locating means and plate locating means interact to guide the plate when the pipette head assembly is brought into proximity thereto, so as to fit the at least one pipette tip into the at least one head cone.

According to the present invention, the need for a precision-engineered high quality work surface tray is avoided. Instead, only the pipette tip holder and associated pipette head cones and plate and head assembly locating means need to be engineered to a low tolerance, typically no more than ±0.4 mm. The work surface tray and associated support for the plate can be made much more cheaply at broader tolerances, typically at least ±1 mm. Production costs may be significantly reduced in this way without affecting performance of the device.

The plate of the pipette tip holder has lateral movement and is supported by the support. In this way, it does not matter whether the plate locating means of the pipette head assembly do not accurately locate the head assembly locating means when initially in contact with one another as the pipette head assembly is lowered to pick up fresh pipette tips. By allowing some lateral movement of the plate, the initial interaction of the head assembly locating means and plate locating means guides the plate into correct position so as to allow pipette tips to fit precisely into their corresponding pipette head assembly cones.

Preferably, the plate locating and head assembly locating means comprise a guide pin and corresponding guide hole for receiving the guide pin. More preferably, the plate locating and head assembly locating means comprise a plurality of guide pins and corresponding guide holes, which are preferably a pair of guide pins and corresponding guide holes disposed at either end of the at least one pipette head cone.

It is preferred that the plate locating means comprise the guide pin and the head assembly locating means comprise the guide hole. In this way, the pipette head assembly includes the guide pins which typically depend below the level of the pipette head cones for engagement with the plate of the pipette tip holder.

In a preferred arrangement, the plate of the pipette tip holder is secured to the support by a locking pin configured to permit lateral movement. For example, the locking pin may have a smaller diameter than the hole through the plate through which it passes. This enables the plate to move laterally when guided by the plate locating means. Advantageously, the plate may be made of a plastics material which enables production costs to be kept to a minimum.

In a further aspect, the present invention provides a pipette assembly for use with the apparatus as described herein.

In a further aspect, the present invention provides a plate which forms part of a pipette holder for use with the apparatus as described herein.

The present invention will now be described in further detail, by way of example only, with reference to the accompanying drawings in which:

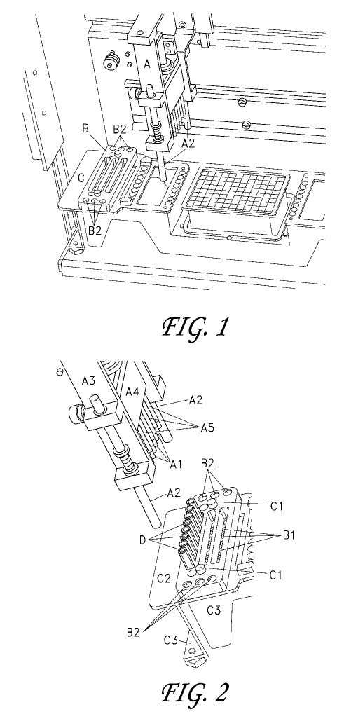

FIG. 1 shows an overview of apparatus according to the invention without pipette tips;

FIG. 2 describes a more detailed view of apparatus according to the invention; and

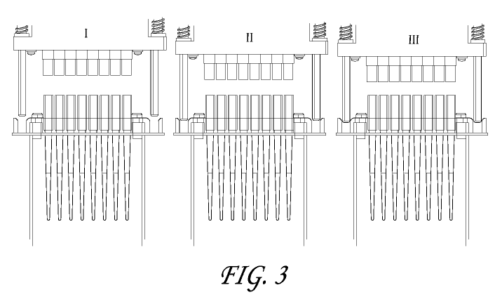

FIG. 3 shows in cross section how an embodiment of the invention works.

Referring to FIG. 1, there is shown a perspective view of a device according to the present invention without the disposable pipette tips being present. Pipette head assembly A is made to narrow tolerances and is mounted on a carriage so as to be moveable horizontally and vertically. Horizontal movement is achieved by attachment of the assembly to rails along the back wall of the apparatus frame and the assembly is driven by a drive belt powered by a motor (not shown). Vertical movement is achieved by mounting the head on a threaded axle which is driven by a further motor. Guide pins A2 depend downwardly from the pipette head assembly. Pipette tip holder plate B is disposed on top of work surface C. The tip holder is made to narrow tolerances and the work surface is made to broader tolerances. Guide holes B2 are shown in tip holder plate B. In this embodiment, the plurality of guide holes is provided, each pair of guide holes at the end of each set of holes for holding pipette tips.

FIG. 2 shows a detailed view of the apparatus with pipette tips D present in one of three rows in the plate. Holes B1 for holding the pipette tips can be seen more clearly in this Figure. Support for this plate comprises a work surface C2 and a support member C3. Locking pins C1 secure the plate to the work surface C2. In this Figure the pipette head assembly A includes pipette head cones A1, a plunger assembly A4 and pipette cylinders A5. Pipette head housing is shown at A3.

In operation, when the pipette head assembly picks up tips, the pipette head cones A1 have to fit into the opening at the top of the pipette tips D. This requires accurate alignment. When the pipette head assembly starts to descend to pick up tips, the guide pins A2 will hit the rim of the guide holes in the tip holder. Since the top of the hole is tapered and the tip of the guide pins are also tapered, the position of the tip holder will automatically be adjusted if the pins are lowered into the guide hole. This sequence of events is depicted in FIG. 3. Panel I of FIG. 3 shows the lower part of the pipette head and a cross section of the pipette tip holder with tips before any contact is made between the two. The tip holder is shown in a position too far to the right to give a good fit to the pipette head cones. Panel II shows the situation after the pipette head has been lowered further. The guide pins have at this stage begun to push the tip holder leftwards aided by the tapered profile at the end of each guide pin and at the upper portion of each guide hole. In panel III the pipette head is lower still and the guide pins have moved past the tapered part of the guide holes in the tip holder, aligning the pipette tips with the pipette head cones. This Figure depicts the alignment only in the left/right dimension; front/rear alignment takes place simultaneously.

1. A pipette head assembly and tip holder apparatus for use in an automated liquid handling device, which apparatus comprises a pipette head assembly mountable in the device and a pipette tip holder comprising locations for holding pipette tips for the pipette head assembly;
wherein the pipette head assembly comprises at least one pipette head cone for liquid delivery to at least one pipette tip, each cone fitting tightly into an opening at the top of the pipette tip, and a plate locating means positioned precisely in relation to the at least one head cone;
wherein the pipette tip holder comprises a plate for aligning the at least one pipette tip for fitting onto the at least one pipette head cone and a support for supporting the plate, which plate is laterally movable on the support and comprises head assembly locating means positioned precisely in relation to the position of location of the at least one pipette tip; and
wherein the head assembly locating means and plate locating means interact to guide the plate when the pipette head assembly is brought into proximity thereto, so as to fit the at least one pipette tip into the at least one head cone.

2. Apparatus according to claim 1, wherein the plate locating and head assembly locating means comprise a guide pin and corresponding guide hole for receiving the guide pin.

3. Apparatus according to claim 2, wherein the plate locating and head assembly locating means comprise a plurality of guide pins and corresponding guide holes.

4. Apparatus according to claim 3, wherein the plurality of guide pins and corresponding guide holes comprise a pair of guide pins and corresponding guide holes disposed at either end of the at least one pipette head cone.

5. Apparatus according to claim 3, wherein each guide pin has a tapered end to facilitate location into a corresponding guide hole.

6. Apparatus according to claim 3, wherein each guide hole has a tapered profile at an upper portion thereof, for facilitating location of the corresponding guide pin.

7. Apparatus according to claim 2, wherein the plate locating means comprise the guide pin and the head assembly locating means comprise the guide hole.

8. Apparatus according to claim 1, wherein the plate is secured to the support by a locking pin configured to permit lateral movement.

9. Apparatus according to claim 1, wherein the positioning of the plate and head assembly locating means, pipette tip locations and pipette head cones is engineered to a tolerance of no more than ±0.4 mm.

10. Apparatus according to claim 1, wherein the plate is made of plastics material.

11. A pipette head assembly for use with the apparatus of claim 1.

12. A plate for use with the apparatus of claim 1.
